(19) United States
(12) Patent Application Publication
(10) Pub. No.: US 2011/0049180 A1
(43) Pub. Date: Mar. 3, 2011

(54) Micro-Ingredient Based Dispenser with User Data Storage Mediums

(75) Inventors: Gregg Carpenter, Marietta, GA (US); David R. Newman, Atlanta, GA (US); Nilang Patel, Mableton, GA (US); Paul A. Phillips, Marietta, GA (US); Arthur G. Rudick, Atlanta, GA (US); Lawrence B. Ziesel, Woodstock, GA (US); Louis Mattos, JR., Douglasville, GA (US); Qiuchen Peter Zhang, Alpharetta, GA (US); Nilton Antonio Moreira Mattos, Roswell, GA (US); H. Brock Kolls, Alpharetta, GA (US); Michael J. Kline, Marietta, GA (US)

(73) Assignee: THE COCA-COLA COMPANY, Atlanta, GA (US)

(21) Appl. No.: 12/873,355

(22) Filed: Sep. 1, 2010

Related U.S. Application Data
(63) Continuation-in-part of application No. 12/784,730, filed on May 21, 2010.
Application No. 12/784,730 is a continuation of application No. 11/276,660, filed on Mar. 9, 2006, now Pat. No. 7,501,758.
Application No. 11/276,660 is a continuation-in-part of application No. 12/767,050, filed on Apr. 26, 2010.

(51) Int. Cl. B67D 7/00; B67D 7/74; B67D 7/78

(52) U.S. Cl. 222/1; 222/129.4; 222/145.6

(57) ABSTRACT

The present application provides a product dispensing system for dispensing one of a number of predetermined products. The product dispensing system may include a product dispenser with a number of micro-ingredients to create the predetermined product, a reading device configured to read or receive data, a container for receiving the predetermined product, and a data storage medium with the data thereon.

### RELATED APPLICATIONS

The present application is a continuation in part of commonly owned Ser. No. 12/784,730, filed on May 21, 2010, entitled “BEVERAGE DISPENSING SYSTEM”, now pending, which is a continuation of commonly owned U.S. Pat. No. 7,757,896, entitled “BEVERAGE DISPENSING SYSTEM”, issued on Jul. 20, 2010, and commonly owned Ser. No. 12/767,050, filed on Apr. 26, 2010, entitled “METHOD FOR MANAGING ORDERS AND DISPENSING BEVERAGES”, now pending, each of which is incorporated by reference herein in full.

### TECHNICAL FIELD

The present application relates generally to product dispensing systems and more particularly relates to a product dispenser such as a beverage dispenser for providing a number of different product or beverage alternatives to a container with a data storage medium thereon.

### BACKGROUND OF THE INVENTION

Commonly owned U.S. Pat. No. 4,753,370 concerns a “Tri-Mix Sugar-Based Dispensing System.” This patent describes a beverage dispensing system that separates the highly concentrated flavoring from the sweetener and the diluent. This separation allows for the creation of numerous beverage options using several flavor modules and one universal sweetener. One of the objectives of the patent is to allow the beverage dispenser to provide as many beverages as may be available on the market in pre-packaged bottles or cans. U.S. Pat. No. 4,753,370 is incorporated herein by reference in full.

These separation techniques have continued to be refined and improved. As is shown in commonly owned U.S. patent application Ser. No. 11/276,553, entitled “Methods and Apparatuses for Making Compositions Comprising an Acid and an Acid Degradable Component and/or Compositions Comprising a Plurality of Selectable Components”, the acid and non-acid components of the non-sweetened concentrate also may be separated. This separation allows for a prolonged shelf life and also enables further concentration of the flavor components. U.S. patent application Ser. No. 11/276,553 is incorporated herein by reference in full.

Beverage dispensers historically have worked by combining a diluent (such as water) with a beverage base. These beverage bases usually have a dilution or a reconstitution ratio of about 3:1 to 6:1. The beverage bases usually come in large containers that require large amounts of storage space and may need to be refrigerated. These requirements often necessitate the need to store these containers far from the actual dispenser and to run long lines from the containers to the dispenser.

Given the improvements in shelf life and concentration described above, there is a desire for a beverage dispenser that can produce even more and different types of beverages while using a smaller footprint. This may be accomplished by breaking down the traditional beverage bases into constituent parts at much higher reconstitution ratios. These parts then may be stored in much smaller packages and stored closer to, adjacent to, or within the beverage dispenser itself. The beverage dispenser preferably can give the consumer multiple beverage options such that the consumer has the ability to customize his or her beverage as desired.

Beverage dispensers incorporating such highly concentrated ingredients have proven to be highly popular with consumers. Consumers tend to enjoy selecting their own customized beverage and also enjoy selecting from a large number of beverages options. As a result of this popularity, there is thus a desire to monitor and manage the use of such dispensers and the ingredients therein without interfering with a consumer's enjoyment.

### SUMMARY OF THE INVENTION

The present application thus provides a product dispensing system for dispensing one of a number of predetermined products. The product dispensing system may include a product dispenser with a number of micro-ingredients to create the predetermined product, a reading device configured to read or receive data, a container for receiving the predetermined product, and a data storage medium with the data thereon.

The data storage medium may include a tag positioned on the container, on a card, or on a wearable article such as a wrist band. The data storage medium may include a bar code and the reading device may include a bar code reader. The data storage medium may include an RFID tag and the reading device may include an RFID reading/writing device. The data storage medium may include a magnetic strip and the reading device may include a magnetic strip reading device.

The data may include a volume of the predetermined product permitted to be received into the container, a number of refills of the predetermined product permitted to be received into the container, a time period for refills of the predetermined product permitted to be received into the container, or the predetermined product permitted to be received into the container. The data may include an identification of the container.

The product dispensing system further may include a control. A number of product dispensers and a number of reading devices may be in communication with the control. The product dispenser may include one or more macro-ingredients and one or more diluents for mixing with the number of micro-ingredients.

The present application further provides a beverage dispensing system for dispensing one of a number of predetermined beverages. The beverage dispense may include a number of micro-ingredients to create the predetermined beverage, a reading device configured to read or receive data, a vessel for receiving the predetermined beverage, and a tag with the data thereon. The tag may be positioned on the vessel, a card, or a wearable article.

The present application further provides a method of dispensing a beverage for a consumer. The method may include the steps of receiving a request for the beverage, preparing the beverage by mixing a number of micro-ingredients, one or more macro-ingredients, and one or more diluents, dispensing the beverage into a container, providing refill data to the consumer, and refilling the container with the beverage according to the refill data.

These and other features and improvement of the present application will become apparent to one of ordinary skill in the art upon review of the following detailed description of the invention when taken in conjunction with the several drawings and the appended claims.

### BRIEF DESCRIPTION OF THE DRAWINGS

FIG. 1 is a schematic view of a beverage dispenser as may be described herein.

FIG. 2 is a perspective view of a dispensing nozzle assembly that may be used with the beverage dispenser of FIG. 1.

FIG. 3 is a schematic view of a user interface for use with the beverage dispenser of FIG. 1.

FIG. 4 is a perspective view of a micro-ingredient beverage dispensing station including an interface portion.

FIG. 5 is a plan view of the micro-ingredient beverage dispensing station including an interface portion.

FIG. 6 is a schematic view of the interface portion of a beverage dispenser valve having a graphical user interface.

FIG. 7 is a plan view of an interface of a beverage dispensing station.

FIG. 8 is a system block diagram for a user interface device for use with a beverage dispenser.

FIG. 9 is a schematic view of a user interface device, vessel activated, for use with a beverage dispenser.

FIG. 10 is a schematic view of a user interface device, vessel activated, configured as an automated beverage system.

FIG. 11 is a schematic view of a quick or full serve restaurant beverage order entry and fulfillment network.

FIG. 12 is a flow chart of a method of selecting and dispensing beverages using a vessel as part of a user interface device.

FIG. 13 is a flow chart of exemplary embodiments of a method of selecting and dispensing beverages using a vessel as part of a user interface device.

FIG. 14 is a flow chart of a method for managing orders and dispensing beverages.

FIG. 15 is a schematic view of an alternative user interface device, vessel activated, configured as an automated beverage system.

FIG. 16 is a plan view of a loyalty card with an RFID tag.

FIG. 17 is a plan view of a wearable device with an RFID tag.

FIG. 18 is a plan view of a loyalty card with a magnetic strip.

### DETAILED DESCRIPTION

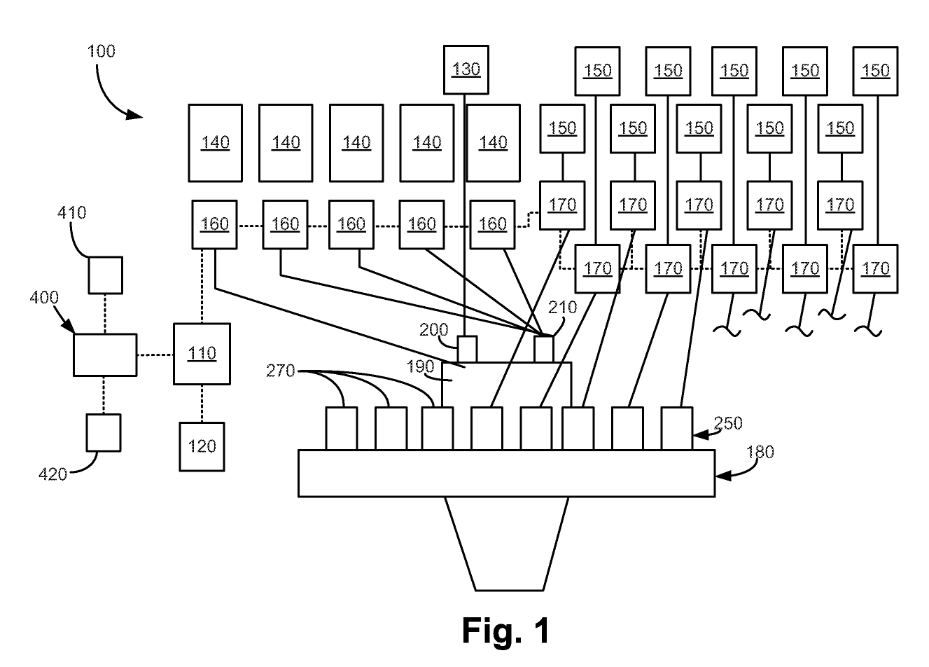

Referring now to the drawings, in which like numerals indicate like elements throughout the several views, FIG. 1 shows a beverage dispenser 100 as is described herein. A user interface 110 may control the functional aspects of the beverage dispenser 100. A consumer may select and/or create numerous types of beverages, blends, and additives using the user interface 110. A control device 120 may support the user interface 110. The control device 120 may be a conventional microcomputer or a similar type of device. The control device 120 may be internal to or remote from the beverage dispenser 100. Although the term beverage dispenser is used throughout, the description herein is applicable to any type of dispenser for any type of product having micro-ingredients therein. The beverage dispenser 100 is thus one example of such a product dispenser.

The beverage dispenser 100 may use any number of different ingredients. In this example, several different types of ingredients may be used: water (plain and/or carbonated) from a water source 130; macro-ingredients from a number of macro-ingredient sources 140; and micro-ingredients from a number of micro-ingredient sources 150. Any number or combinations of sources 130, 140, 150 may be used herein. For example, it may not be necessary to have a macro-ingredient source. HFCS (High Fructose Corn Syrup), which is difficult to pump at high reconstitution ratios, may not be used in certain applications. As such, only a diluent and one or more micro-ingredient sources may be required in certain applications. Other types of ingredients also may be used herein.

The water from the water source 130 may or may not be refrigerated. Other types of diluents may be used herein. A conventional carbonator or a similar type of device may be used to produce carbonated water as desired. The amount of carbonation and the temperature of the diluent may be varied.

Generally described, the macro-ingredients may have reconstitution ratios in the range of about 3:1 to about 6:1. The viscosities of the macro-ingredients typically range from about 100 or higher. Macro-ingredients may include sugar syrup, HFCS, juice concentrates, milk and/or dairy-based products, and similar types of fluids. Similarly, a macro-ingredient base product may include a sweetener, an acid, and other common components. The syrups, sweeteners, and base products generally may be stored in a conventional bag-in-box container remote from the dispenser 100. The macro-ingredients also may be positioned within the beverage dispenser 100 itself. Any type of container may be used herein. The macro-ingredients may or may not need to be refrigerated.

The micro-ingredients may have a dilution or a reconstitution ratio ranging from about ten to one (10:1), twenty to one (20:1), thirty to one (30:1), or higher. Specifically, many micro-ingredients may be in the range of fifty to one (50:1) to three hundred to one (300:1) or higher. The viscosities of the micro-ingredients typically range from about 1 to about 100 centipoise or so. Examples of micro-ingredients include natural and artificial flavors; flavor additives; natural and artificial colors; artificial sweeteners (high potency or otherwise); additives for controlling tartness, e.g., citric acid, potassium citrate; functional additives such as vitamins, minerals, herbal extracts; nutraceuticals; and over-the-counter (or otherwise) medicines such as acetaminophen and similar types of materials. As described above, the acid and non-acid components of the non-sweetened concentrate also may be separated and stored individually. The micro-ingredients may be liquid, powder (solid), or gaseous form and/or combinations thereof. The micro-ingredients may or may not require refrigeration. Non-beverage substances such as paints, dyes, oils, cosmetics, etc., also may be used. Various types of alcohols may be used as micro or macro-ingredients.

Preferably, the micro-ingredients and the micro-ingredient sources 150 may be positioned within or about the beverage dispenser 100 itself as opposed to being remotely positioned in conventional bag in box containers or otherwise. By being positioned about the dispenser 100, we mean that the micro-ingredient sources 150 may be positioned in close proximity to the dispenser 100 such as adjacent thereto, underneath, or in other near by positions. Alternatively, even the micro-ingredients may be positioned remotely from the dispenser 100 such as proximate to the macro-ingredients. Any other type of storage arrangements may be used. Any type of container may be used herein.

The water source 130, the macro-ingredient sources 140, and the micro-ingredient sources 150 each may be in communication with a pump 160, a metering device 170, or other type of flow device. The control device 120 may control the pumps 160 and metering devices 170. Generally described, the water source 130 and the macro-ingredient sources 140 each may be in communication with one of the pumps 160. The pump 160 may be a conventional solenoid pump or a similar type of device. Other configurations may be used herein.

The micro-ingredient sources 150 each may be in communication with one of the metering device 170. The metering device 170 may be a positive displacement pump or a similar type of pumping device. Such a positive displacement pump provides portion control for the more highly concentrated micro-ingredients. An example of the operation of a positive displacement pump is shown in commonly owned U.S. Pat. No. 7,740,152, entitled “Pump System with Calibration Curve”, incorporated herein by reference in full. For example, the positive displacement pump may be a solenoid pump, a gear pump, an annular pump, a peristaltic pump, a syringe pump, a piezo pump or any other type of positive displacement device that is designed to pump a fixed displacement for each pump cycle. Other configurations may be used herein.

The pumps 160 and the metering devices 170 may be in communication with a dispensing nozzle 180. The dispensing nozzle 180 preferably may be a multi-flavor dispensing valve capable of mixing a number of fluids at the same time. Examples of dispensing nozzles that may be used herein are shown in commonly owned U.S. Pat. No. 7,383,966, entitled “Dispensing Nozzle” and commonly-owned U.S. Pat. No. 7,578,415, entitled “Dispensing Nozzle Assembly”. U.S. Pat. Nos. 7,383,966 and 7,578,415 are incorporated herein by reference in full.

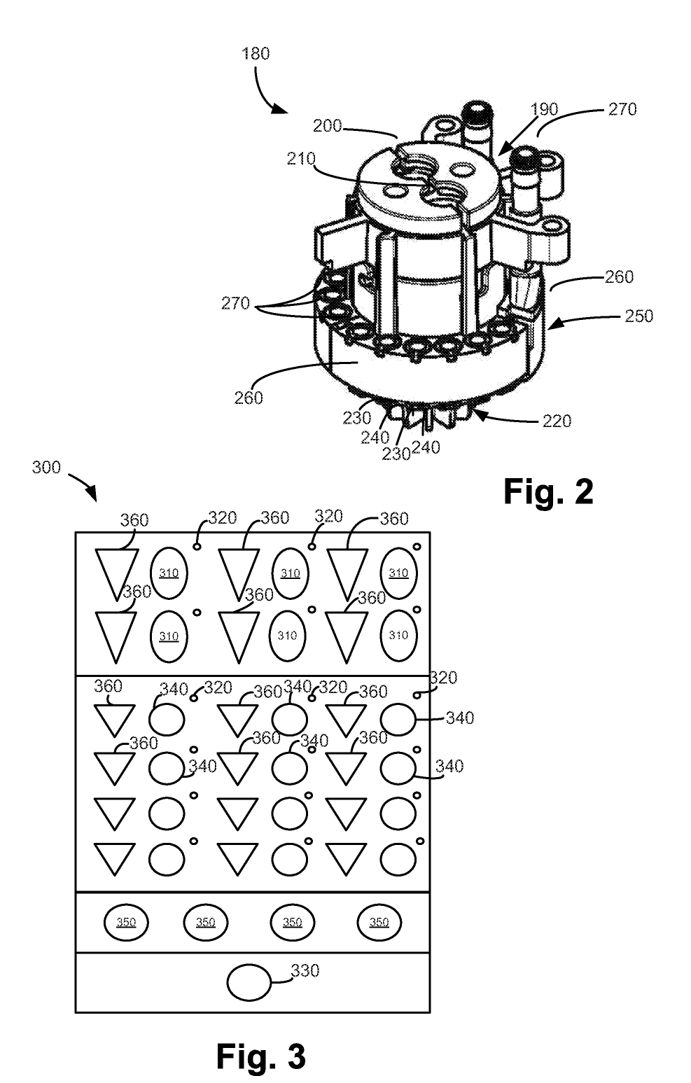

FIG. 2 shows an example of such a dispensing nozzle 180. Generally described, the dispensing nozzle may include a flow director 190 with a number of conduits extending therethrough. In this example, the flow director 190 may have a first conduit 200 and a second conduit 210 extending therethrough. The first conduit 200 may be used for water, other types of diluents, or other fluids. The second conduit 210 may be used for a macro-ingredient such as sweetened concentrate, sugar syrup, HFCS syrup, juice concentrate, or other type of fluids. Positioned beneath the flow director 190 may be a target 220. The target 220 may include a number of vertically extending fins 230 that form a number of U- or V-shaped channels 240. Semi-ellipsoidal, semi-spherical, parabolic, hyperbolic, and any other shape also may be used herein. The water, the macro-ingredients, or other fluids may flow out of the flow director 190 and down along the channels 240 of the target 220 so as to begin mixing. Other configurations may be used herein.

Positioned adjacent to the flow director 190 may be a tertiary flow assembly 250. The tertiary flow assembly 250 may include a number of modules 260. The modules 260 may have a number of conduits 270 extending therethrough. The conduits 270 may have differing sizes and configurations depending upon the nature of the intended flow therethrough. The modules 260 may be replaceable and interchangeable. Each of the modules 260 and the conduits 270 may be in communication with one of the micro-ingredient sources 150 or other types of fluids. The conduits 270 may be aimed towards the target 220 so as to mix the micro-ingredients or other fluid with the water, the macro-ingredients, or other fluid. Other configurations may be used herein. Any number of micro-ingredients or other types of fluids may be used at the same time. Other configurations may be used herein.

FIG. 3 shows an embodiment of the user interface 110, an interface 300. The interface 300 may include a set of predefined product buttons 310. Each product button 310 may represent a different base product or product component. Each product button 310 may have a use indicator 320 that may signal to a consumer that a certain product or ingredient has been selected. A pour/cancel button 330 also may be used to activate the beverage dispenser 100 for the selected beverage. Other configurations may be used herein.

The interface 300 further may include a number of additive buttons 340. In addition to the predefined products defined by the product buttons 310, the additive buttons 340 provide for the addition of additives such as flavorings, colorings, functional attitudes, and the like as described above. Typically, the additives will not be added until about eighty percent (80%) of the minimum drink size is poured so as to guarantee that there is no overdose effect if the drink is stopped prematurely. Additives generally would not be added for top-offs as the known drink size is not guaranteed. In the event that that the user presses the “cancel” button 330, the additives may not be dispensed. The use indicator 320 may flash whenever an additive is being provided. The user interface 300 thus gives visible feedback to the consumer.

The interface 300 also may include portion buttons 350. The portion buttons 350 may be conventional “small”, “medium”, “large”, “extra large”, and the like that correspond to the predetermined beverage sizes. A beverage of any size may be provided given the continuous nature of the dispense herein.

The interface 300 also may include intensity indicators 360. The intensity indicators 360 may include LED's (Light Emitting Diodes) or a similar type of visual interface that shows the relative strength of the beverage. For example, different types of juices may be desired to be mixed together so as to provide a custom-blended beverage. The intensity indicator 360 also may be used to vary the amount of additives or even the nature and amount of the concentrate, sweetener, or other types of ingredients.

In addition to the interfaces described above, additional graphical interfaces may be provided. For example, nutritional information may be provided. Whenever a portion button 350 or an intensity button 360 is selected, the nutritional information that reflects the characteristics of the selected drink may be displayed. For example, the amount of calories in the beverage as mixed by the consumer may be displayed. The consumer may then have the option to change the nutritional value of the beverage as desired. The computer user interface 300 also may restrict and/or allow which and how much of various ingredients may be used. Other configurations may be used herein.

The computer user interface 300 may provide an individual consumer with secure access by password, smart card, biometric identification, credit card, RFID, or otherwise. The user interface 300 may provide the consumer with formulations previously selected, promotions, and other types of information. The user interface 300 may restrict and/or allow which and how much of various ingredients may be used by a consumer. Consumer preferences also may be retained and used for new product development.

In addition to the graphical interface, the beverage dispenser 100 as a whole may supply dispenser statistics and troubleshooting information. For example, the delay time for the start of the pumps 160 or the metering devices 170, the times for the vent and/or flush cycles, the portion cycles, etc. may be accessed through the user interface 110, 300. This interface 110, 300 may be password or otherwise protected. The user interface 110, 300 may communicate and/or be accessed as needed with a network or other source for troubleshooting or repair and for notifications or alerts, for example, of a potential incorrect dose of ingredients.

In use, a consumer may select the desired beverage from the user interface 110. The beverage dispenser 100 thus provides the consumer with the ability to create and blend numerous types of beverages as desired. The consumer can alter the ingredients as well as the intensity of the beverage to taste. As such, the consumer can submit an entire “recipe” for a custom beverage. Alternatively, the consumer can request a “branded” beverage. For example a “CHERRY COKE®” beverage sold by The Coca-Cola Company of Atlanta, Ga. is more than just a “COCA-COLA®” beverage with the addition of a shot of cherry flavoring. Rather, it is a specific branded beverage with a consistent taste. The beverage dispenser 100 thus may provide as many “branded” beverages as may be available on the market in bottles, cans, or otherwise.

The interface 110, with the control 120, then instructs the individual pumps 160 and/or the metering devices 170 to dispense the appropriate ingredients in the appropriate proportions to the dispensing nozzle 180. The mixed beverage then flows into the consumer's cup in the predetermined proportions for a given flow rate. The pumps 160 and the metering devices 170 may be pulsed on and off as desired to vary the flow rate. Such pulsing, for example, may ensure mixing of the micro-ingredients and may provide for a varied carbonation level. The beverage may be mixed at the dispensing nozzle 180 or anywhere downstream of one or more of the sources 130, 140, 150 (e.g., back room, in-line, etc.) Different flow rates and flow timing may be employed, e.g., certain fluid streams may be added early or late, certain fluid streams may be pulsed, etc.

The use of the individual pumps 160 and/or the metering devices 170 for the water source 130, the macro-ingredient sources 140, and the macro-ingredient sources 150 provides the ability to dispense the appropriate ingredients in the appropriate proportions for a given flow rate during a continuous pour. In other words, as opposed to a conventional batch operation where a predetermined amount of ingredients are combined, the beverage dispenser 100 provides for continuous mixing and flows in the correct ratios for a pour of any volume. The beverage dispenser 100 thus has applicability to conventional countertop devices, vending devices, and various types of bottling and filling devices. Although the invention is described in terms of the beverage dispenser 100, the invention is applicable to the combination of any types of ingredients, wet or dry. For example, commonly owned U.S. patent application Ser. No. 11/276,549, entitled “Juice Dispensing System”, is specifically directed towards the use of the concepts described herein in the juice field. U.S. patent application Ser. No. 11/276,549 is incorporated herein by reference in full.

Referring again to FIG. 1, the beverage dispenser 100 also may include a consumer data system 400 in communication with the user interface 110 and the control device 120. The consumer data system 400 may include a communication device 410. The communication device 410 may include a video touch screen, a video screen and keyboard, or any other type of conventional input/output device. The communications device 410 may be part of the user interface 110 or a separate element. Other configurations may be used herein.

The communications device 410 may prompt the consumer to input data on various types of biometric, health, lifestyle, and/or other types of information. Based upon the consumer's input, the control device 120 may analyze the data and may suggest a beverage or beverage ingredients that may be ameliorative, beneficial, or simply amusing the consumer in light of the data input.

Health parameters may include height, weight, blood pressure, blood glucose levels, insulin levels, cholesterol levels, bone density, heart rate, other types of metabolic information, body mass percentages, body temperatures, smoking history, pregnancy, overall medical history, etc. Lifestyle questions may include mood, intensity workouts, etc. Other types of categories may include the time of day, outside temperature, current events, team affiliations, etc. Any type of data may be requested.

Based upon the inputted data, the communications device 410 of the consumer data system 400 may suggest a beverage with various types of vitamins, minerals, herbal extracts, over-the-counter medicines, colorings, etc. A beverage with a specific amount of calories may be suggested. For example, a beverage with a “bones” package, i.e., Vitamin D and calcium; an “anti-oxidant package”, i.e., Vitamins C and E and zinc; a “heart package”, i.e., plant sterols and B vitamins; and many other additives or mixtures may be suggested. Once a beverage and/or the additives are selected, the appropriate micro-ingredients 150 or other elements may be dispensed via the pumps 160 and the metering devices 170 as is described above. The consumer data also may be stored and compared to the current data.

In addition to the communications device 410 as described above, the consumer data system 400 also may include one or more biometric sensors 420. The biometric sensors may include automated devices to gather the desired health data or other information. The biometric sensors 420 may include a scale, a blood pressure cuff, a breathalyzer, a blood analyzer, a hair analyzer, an EKG, facial recognition, fingerprint recognition, retinal recognition, etc. Any type of monitoring device may be used herein. Any number of biometric sensors 420 may be used together. The biometric sensors 420 may be in communication with the control device 120 as described above. Other configurations may be used herein.

The beverage dispenser 100 described herein is thus one example of a dispenser capable of dispensing a number of beverages or other products based upon the use of multiple micro-ingredients 150 with high reconstitutions ratios. Such a dispenser thus provides multiple beverages and other products to a consumer in a relatively small foot print. The dispenser 100 is easy to use and thus promotes extensive consumer interaction therewith.

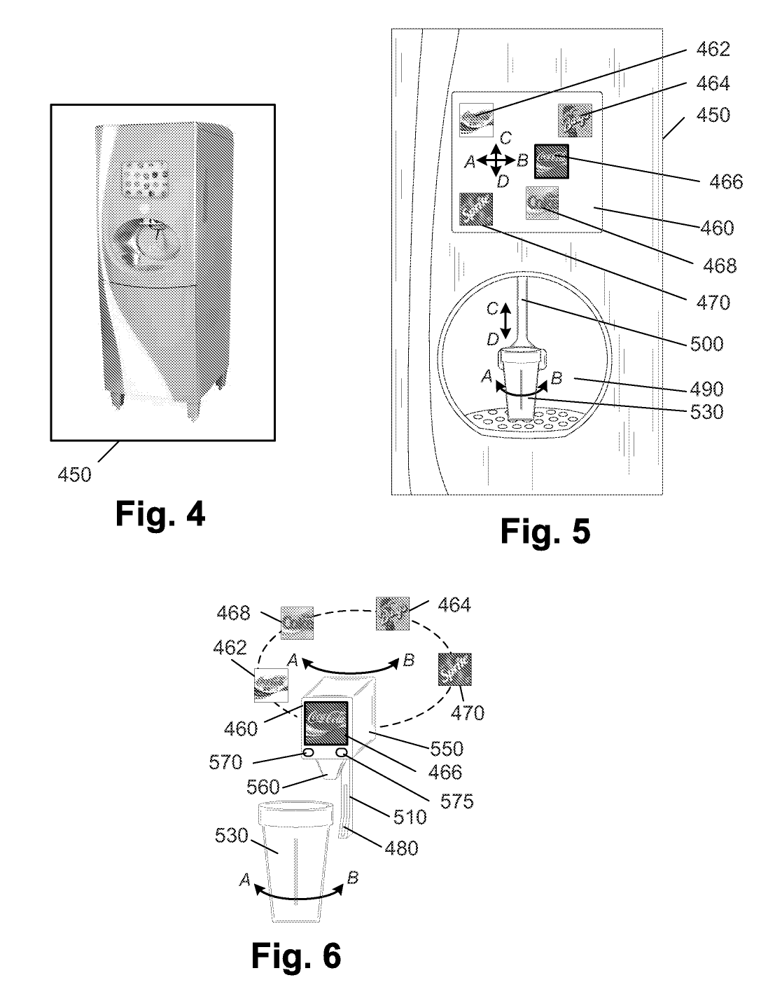

FIGS. 4 and 5 show an example of a micro-ingredient beverage dispensing station 450. The micro-ingredient beverage dispensing station 450 may manage the dispensing of a number of concentrated ingredients, water, dairy, soy, sweetener, carbonated water, and/or or other beverage forming ingredients in precise recipes to form hundreds of different beverages as is described above. To effectuate the ability of a user to select which beverage recipe to dispense, a user accessible graphical user interface 460 may be provided. Similar to that described above, a menu of beverage choices may be displayed on the graphical user interface 460 such as beverage selections 462, 464, 466, 468, 470. Any number of selections may be used herein.

For example and not as a limitation, a COCA-COLA ZERO™ beverage may be dispensed by selecting the COCA-COLA ZERO™ beverage selection 462. In a similar fashion, a BARQ'S ROOT BEER® beverage may be dispensed by selecting the BARQ'S ROOT BEER® beverage selection 464. A COCA-COLA® beverage may be dispensed by way of the beverage selection 466, a DIET COKE® beverage may be dispensed by way of the beverage selection 468, and a SPRITE® beverage may be dispensed by way of the beverage selection 470. The beverage dispenser 450 may be configured to dispense hundreds of beverage types limited only by the ingredients needed to formulate a beverage recipe.

To facilitate the selection of the beverage type from the graphical user interface 460, a user generally was required to touch a touch screen. If the user's hands were full, this would require the user to put something down in order to free a hand to then make a beverage type selection. In certain other situations, the location of the touch screen may be too high for easy access by children or other types of consumers without assistance.

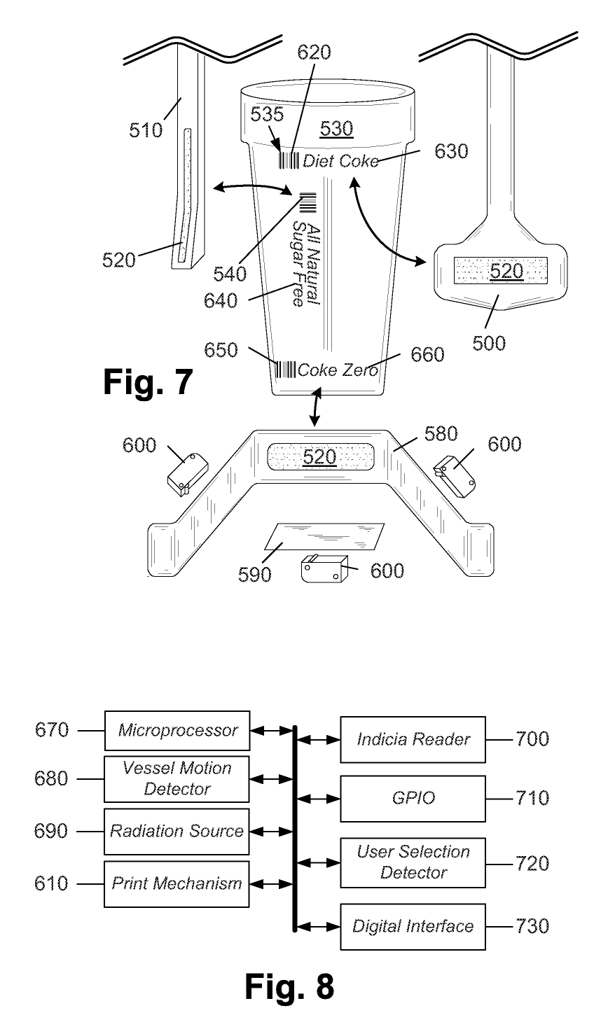

An advantage herein is that an additional user interface device 480 may be implemented to facilitate the ability to select and optionally dispense a beverage type. In this regard, the beverage dispenser 450, a beverage dispense region 490, an ice dispense lever 500, a beverage dispense lever 510 (shown in FIG. 6) and/or other locations may have a user interface device 520 (shown in FIG. 7) capable of detecting the motion of a vessel 530. For purposes herein, the user interface device 520 also may be referred to as a system 520. The vessel 530 may have a data storage medium 535 positioned thereon. In this example, the data storage medium 535 may be machine readable indicia 540 such as a barcode.

As is illustrated in FIG. 5, a user may rotate the vessel 530 to move the selection on the graphical user interface 460 in the “A-B” direction. The user also may move the vessel 530 in the up or down direction to move the selection of the graphical user interface 460 in the “C-D” direction. The vessel 530 may be provided with the machine readable indicia 540 that encircle the entire perimeter of the vessel 530 such that the user interface device 520 can read the indicia no matter what direction the vessel 530 is positioned.

This one handed user interface is an alternative to having to touch the touch screen 460 and thus effectuates that ability to select and optionally dispense the desired beverage. In a number of examples, this one handed beverage selection interface speeds beverage selection and dispense time in the crew-serve environment commonly found in quick or full serve restaurants environments. In general, a “crew-serve” dispense is operated by a “crew member” and a “self-serve” dispenser is operated by a consumer. The one handed operation frees the crew members from having to put down what they are carrying so as to select and dispense a beverage. In another example, children and other consumers that may be less able to reach or see the elevated graphical user interface 460 may make and optionally dispense a beverage selection by using only vessel motion to interact with the beverage dispenser. In another example, wheelchair-bound consumer or others have difficulty reaching the elevated graphical user interface 460 also may benefit from being able to select and dispense a beverage using only vessel motion to interact with the beverage dispenser.

Referring to FIG. 6, there is illustrated one example of an interface portion of a beverage dispenser having the graphical user interface 460. In a conventional fountain dispenser, a number of single flavor valves were orientated such that a user could only choose between finite numbers of beverage flavors. Embodiments of conventional fountain dispensers typically support a dozen or less valves and as such a finite number of beverage type choices.

An advantage herein is that a single valve 550 such as the dispensing nozzle 180 described above may be configured with the graphical user interface 460. The dispenser lever 510 may be configured with the user interface device 520 such that a user may interact with the beverage valve to select a beverage type and then dispense the beverage into the vessel 530. In this regard, a user may move or rotate the vessel 530 in the “A-B” direction causing the beverage type to change on the graphical user interface 460. As the user rotates the vessel 530 in the “A” direction, the graphical user interface 460 displaying the flavor label changes from COCA-COLA® 466 to SPRITE® 470 to BARQ'S ROOT BEER® 464 to DIET COKE® 468 to COCA-COLA ZERO™ 462 and then back to COCA-COLA® 466. Rotation of the vessel in the “B” direction reverses the display pattern. The user thus has the ability to use the vessel 530 to select a beverage type and then dispense the beverage by activating the lever 510. Also shown in FIG. 6 is a beverage dispenser nozzle 560 with a number of touch buttons 570, 575. The touch buttons 570, 575 may effectuate the ability of a user to interact with the valve 550 and optionally dispense the beverage by touch.

The valve 550 may be retrofit to a conventional fountain dispenser or an automated beverage dispenser (described below). In this regard, the valve 550 having the graphical user interface 460 may be incorporated into existing conventional fountain equipment and automated beverage systems so as to effectuate the ability to select and dispense numerous beverages from the single valve 550 with the use of a user interface device 460.

Referring to FIG. 7, there is illustrated one example of a number of interfaces capable of effectuating the ability to select and initiate the dispensing of a beverage from a beverage dispensing station. The user interface device 520 may be incorporated into the dispense lever 510, the ice lever 500, or into the beverage dispense area using a dispense area lever 580, a dispense plate 590, or another device. As the vessel 530 comes into proximity of the system 520, the vessel motion may be detected and used to facilitate a selection of a beverage type on the graphical user interface 460. Once the beverage type has been selected, dispensing may be initiated by pressing the lever 510, the lever 500, actuating a number of switches 600, or otherwise. The levers, switches, combinations thereof, and/or other types of actuators may be referred to as the dispense actuators. In this regard, the dispense actuators may be used to effectuate the dispensing of the beverage type selected. A number of levers such as the levers 500 and 510 may be utilized with the switches 600 so as to serve as a dispense actuator to enable a crew member, consumer, or other users to initiate and control dispensing of the beverage.

The switches 600 may be actuated by pushing the vessel 530 against the dispense lever 580 or the dispense plate 590. The dispense area lever 580 and the dispense plate 590 may have enough freedom to move such that one of the switches 600 may be actuated when the lever or plate are pushed by the vessel 530. In a multi-level menu on the graphical user interface, pushing the vessel 530 against the left side of the dispense area lever 580 and thus actuating the switch 600 may move the graphical user interface display to the next menu level while pushing the vessel 530 against the right side of the dispense area lever 580 and thus actuating the switch 600 may bring the graphical user interface back to the previous menu level.

In addition to detecting the motion of the vessel 530 and using such vessel motion to facilitate a beverage selection and optionally a beverage dispense, the system 520 may be configured to print the data storage medium 535 in the form of indicia on the vessel 530. During the beverage selection and/or beverage dispense, a print mechanism 610 (shown in FIG. 8) associated with system 520 may print indicia on the vessel 530. Such indicia may be the type or kind of beverage selected and dispensed, a barcode that is machine readable, health and wellness information, product contents information, and/or other indicia. As an example and not as a limitation, illustrated in the FIG. 7 is a machine readable indicia 620 and product information 630 horizontally oriented as printed by the system 520 associated with the lever 500. Also illustrated in the FIG. 7 is the machine readable indicia 540 and product information 640 vertically orientated as printed by the system 520 associated with the lever 510. Also illustrated in the FIG. 7 is a machine readable indicia 650 and product information 660 horizontally orientated as printed by the system 520 associated with the lever 580. Note that each of these indicia, 540, 620, and 650 could each be horizontally oriented at different levels on the vessel 530 as shown with indicia 620 and 650, but with the indicia completely encircling the vessel 530 to avoid the need for the user to rotate the indicia so it can be read by the user interface device 520 in any orientation. In this application, the user would simply elevate the cup to the desired level so that the desired indicia are read by the user interface device.

Referring to FIG. 8, there is illustrated one example of a system block diagram for the user interface device 520 for use with the beverage dispenser. The system 520 may be integrated into a beverage dispensing station, a fountain dispenser, an automated beverage system, or other type of a beverage dispenser. Indeed the system may be integrated into any dispensing mechanism for dispensing any type of product, including, without limitation, food products, pharmaceutical products, candy, coffee (including beans and ground), paint, or any other product that can be dispensed and needs to be distinguished from other products that can be dispensed from the same dispensing mechanism. The system 520 may be utilized to effectuate the use of the vessel 530 to select a beverage type and optionally dispense a beverage. In addition, such a system 520 may be utilized to read the data storage medium 535 in the form of machine readable indicia and/or print indicia on the vessel surface. Reading such indicia may effectuate the ability to program the dispenser to dispense certain beverage types, control access to the beverage dispensing station, program the beverage dispensing station, and/or effectuate other features.

The system 520 may have a microprocessor 670. Such a microprocessor 670 may be an INTEL, MOTOROLA, AMD, ZILOG, MICROCHIP, RABBIT, and/or other types and kinds of microprocessors, as may be required and/or desired. The microprocessor 670 may be interconnected with a vessel motion detector 680. A radiation source 690 may be used to illuminate a portion of the surface of the vessel 530. The backscatter then may be captured by the vessel motion detector 680. In this regard, the vessel motion detector 680 may determine the motion of the vessel 530 by monitoring the changes in the backscatter. The backscatter also may be referred to as the scatter data. The vessel motion effectuates the ability of the microprocessor 670 to implement instructions that perform the steps of determining the motion of the vessel 530 by analysis of the scatter data, communicating data based in part on the scatter data, and effectuates the ability of the user to rotate or move the vessel to select a beverage type.

The radiation source 690 and the vessel motion detector 680 may be similar in design and manufacture to components found in an optical personal computer mouse or other type of optical pointing device design. In addition, the radiation source and the vessel motion detector may employ visible and non-visible light and/or other radiation sources and detectors. Furthermore, lasers, radio frequency techniques, and/or other radiation sources and/or vessel motion detector techniques and/or components may be employed in the design. Mechanical encoders also may be used in part as a vessel motion detector. The vessel motion detector 680 also may utilize mechanical position detection, rotary encoders, vessel contact means, and/or other vessel motion detection techniques.

Interconnected with the microprocessor 670 may be the print mechanism 610. Such a print mechanism 610 may be configured to print indicia on the surface of the vessel 530, as illustrated in FIG. 7, and/or in other ways. Such a print mechanism 610 may print by way of thermal, ink jet, radiation exposure of reactive inks applied on the vessel surface, and/or by other print methods. The print mechanism 610 may create graphics and text indicia by way of pixel based printing methods such as dot matrix style and/or by way of other type and or kinds of printing methods.

Interconnected with microprocessor 670 may be an indicia reader 700. The indicia reader 700 may read and process machine readable codes. Such machine readable codes may be a MICROSOFT TAG, a DATAMATRIX CODE, a QRCCODE, a barcode, graphics, black and white tags, color tags, and/or other types of machine readable indicia. Other types of readers may be used herein as is described below.

Interconnected with the microprocessor 670 may be a number of general purpose inputs and outputs (GPIO) 710. In this regard, the microprocessor 670 may read and control external devices by way of the GPIO 710. For example and not as a limitation, the switches 600 may be monitored by the GPIO 710. The GPIO 710 also may be used to control lighting around the beverage dispense area 490 or to monitor and control other aspects and devices.

Interconnected with the microprocessor 670 may be a user selection detector 720. The user selection detector 720 may be used to detect the vessel 530 or the motion of the lever 500, the lever 510, and/or the lever 580. In this regard, the user selection detector 720 may be used to detect vessel motion so as to determine that a selection has been made by the user. For example and not as a limitation, the user moves the vessel 530 to select a beverage type. Once the beverage type is selected on the graphical user interface 460, the user can then tap or move the lever 500, the lever 510, and/or the lever 580. Such tapping or lever movement may be detected by the user selection detector 720 and used to confirm the selection the beverage type. In operation, this confirmation of the selected beverage type may be followed by the dispensing of ice, the beverage, and/or other actions. The user selection detector 720 may make use of an accelerometer, switches, and/or other user selection detector devices.

Interconnected with microprocessor 670 may be a digital interface 730. The digital interface 730 may be a universal serial bus (USB) port, a CAN bus interface, an infrared communication port, a serial port, a radio frequency port, or other type or kind of digital communication port. In this regard, the system 520 may be interfaced to and communicate with other digital devices by way of the digital interface 730.

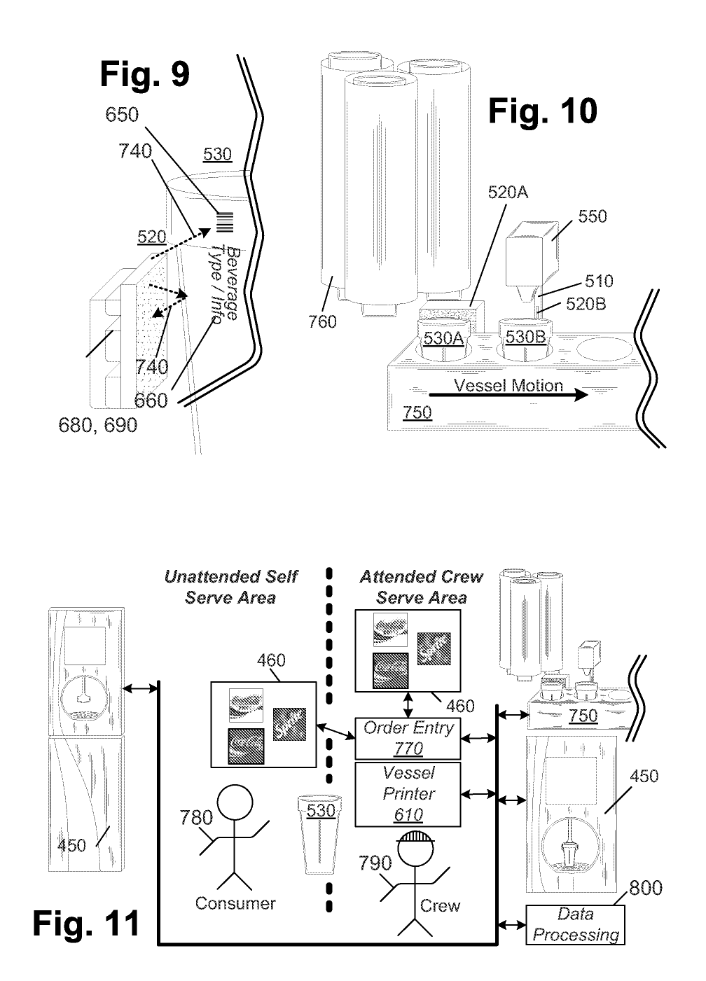

Referring to FIG. 9 there is illustrated one example of the user interface device 520, vessel activated, for use with a beverage dispenser. The radiation source 690 may emit radiation 740 that reflects off the surface of the vessel 530 and may be monitored by the vessel motion detector 680. The vessel motion detector 680 may detect motion of the vessel 530 by way of received reflected radiation off the vessel surface from the radiation source 690 as scatter data associated with the vessel motion. The microprocessor 370 may implement instructions that perform the steps of determining the motion of the vessel by analysis of the scatter data. The data then may be communicated based in part on the scatter data so as to enable the user to interact with the graphical user interface 460. This effectuates the ability of the user to rotate or move the vessel 530 to select a beverage type and dispense the beverage.

The print mechanism 610 may be utilized to print the data storage medium 535 with the beverage type, beverage information, machine readable codes, and/or other indicia on the vessel 530. Such printing may be effectuated by way of transfer of ink jet printing, thermal printing, or radiation activated ink exposure with use of a radiation sources.

Referring to FIG. 10, there is illustrated one example of the user interface device 300, vessel activated, configured as an automated beverage system 750. The automated beverage system (ABS) 750 may be operationally related to an order entry system. Such an order entry system may be found at a quick or full serve restaurant. In operation, an order placed by way of the order entry system may cause the automated beverage system 750 to dispense a vessel from a vessel dispenser 760 and may be filled with a beverage automatically.

An advantage herein is that the data storage medium 535 in the form of the indicia may be printed on the vessel 530 as initiated by way of an order being placed in an order entry system 770 (shown in FIG. 11). The indicia printed on the vessel 530 may include machine readable indicia, beverage type, and/or other indicia, and may be used to confirm that the vessel is authorized to receive product from the product dispenser. The vessel 530 then may be automatically dispensed from the vessel dispensers 760 into a vessel position 530A. The dispensed vessel 530 may have the indicia printed onto the vessel 530 as it is conveyed past the system 520A. Upon reaching a vessel position 530, the lever 510 having a system 520B positioned thereon may read the indicia, configure the beverage type to be dispensed, and then dispense the beverage into the vessel 530. The data storage medium 535 on the vessel 530 may be used to determine the beverage type to be dispensed and optionally other beverage parameters such as size, diet sweetener, non-diet sweetener, and/or the indicia that may be used to determine other aspects or features. The vessel dispenser 760 may be configured for small size vessels, medium size vessels, large size vessels, and/or configured in other ways. The dispenser may be configured to dispense automatically a custom tailored beverage to the individual customer based on the biometric or other data, such as a favorite beverage, pertaining to that customer.

An advantage herein is that not only may the data storage medium 535 in the form of the printed indicia be utilized to configure the beverage dispensing stations 450, the beverage valves 550, and the automated beverage systems 520 to dispense a desired beverage type, but the data storage medium 535 also may play a role in insuring order accuracy and consumer satisfaction. In this regard, by printing the beverage type on the surface of the vessel 530, the crew member may ensure that the consumer receives the correct beverage. Likewise if a consumer is purchasing several drinks, perhaps belonging to several family members, the humanly readable indicia, 630, 640, and 660 printed on the surface of the vessel 530 ensures that each family member receives the correct beverage type. A fountain dispenser, the automated beverage system 750, the beverage dispensing station 450, and the beverage dispenser may be referred to as a beverage dispenser, a beverage dispensing station, and/or crew-serve beverage dispenser.

Referring to FIG. 11, there is illustrated one example of a quick or full serve restaurant beverage order entry and fulfillment network. A consumer 780 may place an order with a crew member 790. Such an order may be placed in the order entry system 770. The order placement may require that the crew member select the beverage type desired by the consumer by way of the graphical user interface 460. Alternatively, the consumer may be able to make a beverage selection from a consumer accessible graphical user interface 460. The beverage dispensing station 450, the automated beverage system 750, the graphical user interfaces 460, the vessel printer 610, and the order entry station 770 may be networked together with a data processing system 800. In this regard, the data processing system 800 may be a local or a global network based data processing resource or a system accessible over a global network. The Internet may be considered a global network. The data processing system 800 may be utilized to effectuate the running of a quick or full serve restaurant including order entry management. The data processing system 800 may act as an overall control in communication with the beverage dispensing stations 450 and the other components herein.

The vessel 530 may be printed with the data storage medium 535 in the form of indicia and the crew member may hand the vessel 530 to the consumer. The consumer then may use the beverage dispensing station 450 to fill the vessel 530. The indicia printed on the vessel 530 may contain the order identification and the act of the consumer filling the vessel 530 at the beverage dispensing station may cause the indicia to be read including the order identification. Information about what the consumer dispensed into the vessel 530 then may be communicated to the data processing system 800 managing orders such that the beverage information may be added to the order information. In this regard, order information may include the types, kind, and volume of beverage dispensed by the consumer.

This feature overcomes the current shortcomings that when a consumer buys a beverage in a self-serve environment, the crew member adds to the order a drink entry with no details as to what flavor or brand of beverage the consumer is going to consume. In addition, there is no way to track refills in a self-serve environment and as such the order information may be incorrect with respect to the type, kind, and volume of beverage dispensed by the consumer.

The crew-server member may initiate beverage filling by way of the automated beverage system 750. The consumer's order information, beverage type, other product information, and/or other indicia may be printed on the vessel 530 and filled at the automated beverage system 750. The crew member then benefits from having the beverage type, order identification, and/or other indicia printed on the surface of the vessel 530 to ensure that the correct beverage order is provided to the correct consumer. The consumer also benefits in that when they receive the beverages and distribute them to family members, each consumer is ensured that they are getting the correct beverage.

The crew-server member 790 may use the vessel 530 in combination with the user interface device 520 to select quickly a beverage type and dispense the beverage at the beverage dispensing station 450. In this regard, the vessel 530 may be preprinted and read at the beverage dispensing station 450 and/or may be printed after the crew member 790 selects the desired beverage.

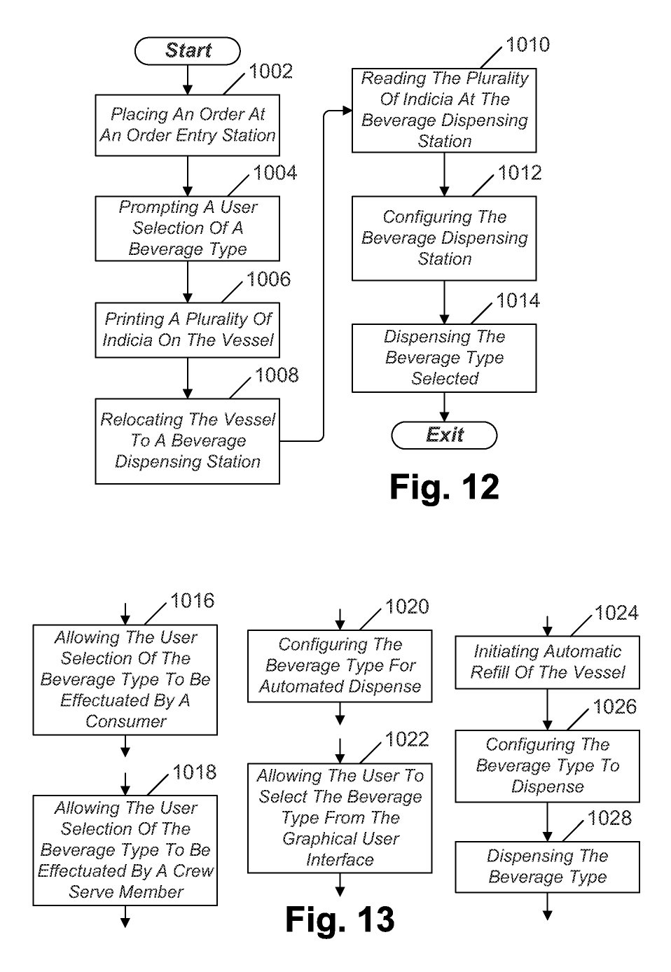

Referring to FIG. 12, there is illustrated one example of a method for managing orders and dispensing beverages. An order may be place by way of an order entry station in a quick or full serve restaurant environment. The user may be prompted to select a beverage type, the beverage type may be printed on the vessel 530, the vessel 530 may be read in a beverage dispensing station, the beverage dispensing station may be configured, and the selected beverage type may be dispensed into the vessel 530. The beverage dispensing station also may be referred to as an automated beverage system 750. The method begins in block 1002.

In block 1002, an order is placed at an order entry station. In block 1004, a user is prompted to make a beverage type selection. Such a beverage type selection may be made on a graphical user interface 460 by a consumer or on a graphical user interface 460 by a crew-server member. In block 1006, the data storage medium 535 in the form of a number of indicia may be printed on the vessel 530. Such indicia may be printed by way of the vessel printer 610 or otherwise. In addition, such indicia may be the type or kind of beverage selected and dispensed, a barcode that is machine readable, health and wellness information, product contents information, consumer loyalty data, and/or other type of information.

In block 1008, the vessel 530 may be relocated to the beverage dispensing station or an automated beverage system. The vessel 530 may be handed to the consumer or the automated beverage system may begin to fill the order. In block 1010, the indicia may be read on the surface of the vessel 530 at the beverage dispensing station or the automated beverage system. In block 1012, the beverage dispensing station or the automated beverage system may be configured to dispense the beverage type selected. In block 1014, the beverage type selected may be dispensed into the vessel 530. The method is then exited.

Referring to FIG. 13, examples of a method for managing orders and dispensing beverages are shown. In block 1016, the selection of the beverage type may be effectuated by a consumer. In this regard, the consumer may have access to a beverage selection graphical user interface. In block 1018, the selection of the beverage type may be effectuated by a crew member. The crew member may have access to the beverage selection graphical user interface. In block 1020, the steps of reading the data storage medium 535 in the form of indicia from the vessel 530, configuring the beverage dispenser, and dispensing the beverage type into the vessel 530 may be performed in an unattended manner by way of the automated beverage system. Upon order entry, the vessel 530 may be filled without the intervention of a crew member. In block 1022, the user may be allowed to select the beverage type from the graphical user interface by moving and/or rotating the vessel 530. In block 1024, an automatic refill of the vessel 530 may be initiated by reading the printed indicia on the surface of the vessel 212 at the beverage dispensing station. In block 1026, the beverage dispensing station may be configured to dispense the beverage type based on the indicia read on the surface of the vessel 530. In block 1028, the selected beverage type may be dispensed into the vessel 530. The method is then exited.

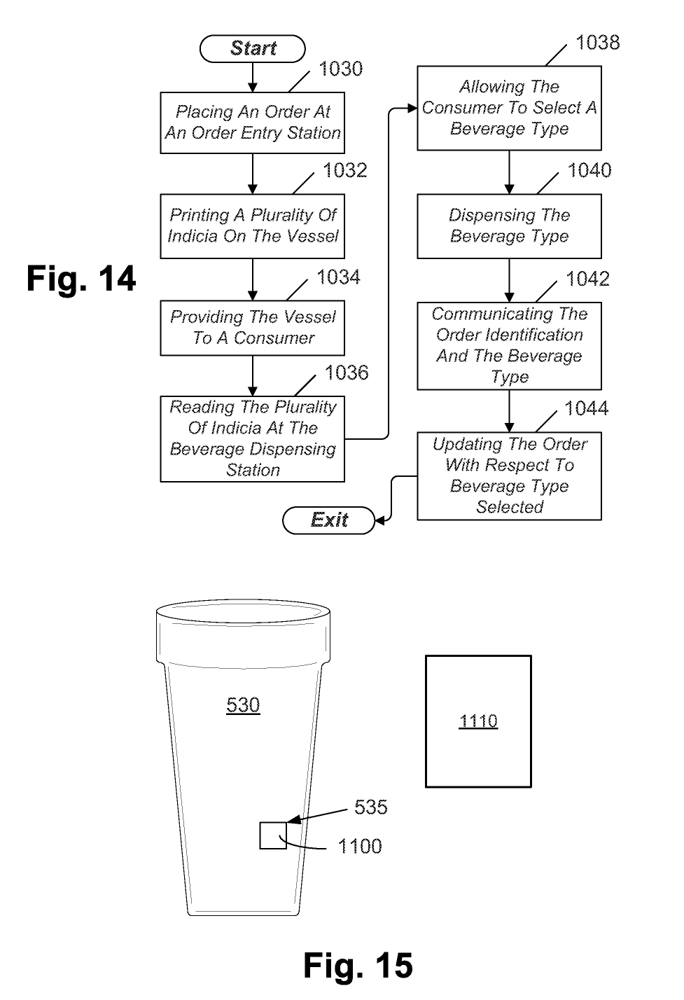

Referring to FIG. 14, one example of a method for managing orders and dispensing beverages is shown. An order may be placed at an order entry station and a vessel 530 may be printed with the data storage medium 535 in the form of indicia and provided to a consumer. The printed indicia may include order identification indicia. The consumer may then present the indicia printed on the vessel 530 for reading at a beverage dispensing station. The beverage dispensing station may allow the consumer to select a beverage type and the beverage may be dispensed into the vessel 530. A data communication between the beverage dispensing station and the order entry data processing system may then be effectuated that includes order identification data and the beverage type data. This data communication may serve to update the order with respect to the beverage type selected, as well as update other aspects of the order. The method begins in block 2002.

In block 1030, an order at an order entry station may be placed. In block 1032, the data storage medium 535 in the form of a number of indicia may be printed on the vessel 530. Such indicia may include the order identification and other information. In block 1034, the vessel 530 may be provided to the consumer. In block 1036, the indicia may be read at the beverage dispensing station by the system 520. In block 1038, the consumer may be allowed to select a beverage type. In block 1040, the beverage type may be dispensed into the vessel 530. In block 1042, the order information and the beverage type also including the volume dispensed and other attributes of the beverage product may be data communicated to a data processing resource such as data processor 800 or to a global network based data processing resource. In block 1044, the order with respect to the beverage types selected and the order identification received may be updated. In this regard, the consumer's order may now track the beverage type and other beverage attributes based in part of the beverage type dispensed. The method is then exited.

In addition to the data storage medium 535 being in the form of written indicia such as barcodes and the like, the machine readable indicia 535 also may be in the form of a radio frequency identification (“RFID”) tag 1100 and the like. The RFID tags 1100 may communicate with an RFID reader 1110. Specifically, the RFID tag 1100 may be a proximity card while the RFID reader 1110 may be a proximity card coupling device. Such proximity cards may be a MIFAIR e-card offered by NXP Semiconductors of Eindhoven, Netherlands. Similar cards may be offered by Paytec Spa of Como, Italy and the like. Similar devices may be used herein. The RFID tag 1100 may be contact or non-contact based.

The RFID reader 1110 may read and write information to and from the RFID tag 1100. The RFID reader 1110 may be associated with the user interface devices 520 or other aspects of the beverage dispensing station 450, the automated beverage system 750, and elsewhere as desired. The same and other types of data described above with the data storage medium 535 in the form of written indicia also may be used with the data storage medium 535 in the form of the RFID tag 1100. Multiple types of data storage mediums also may be used together. The RFID reader 1110 may communicate with the microprocessor 670, the data processing system 800, and other components as is described above.

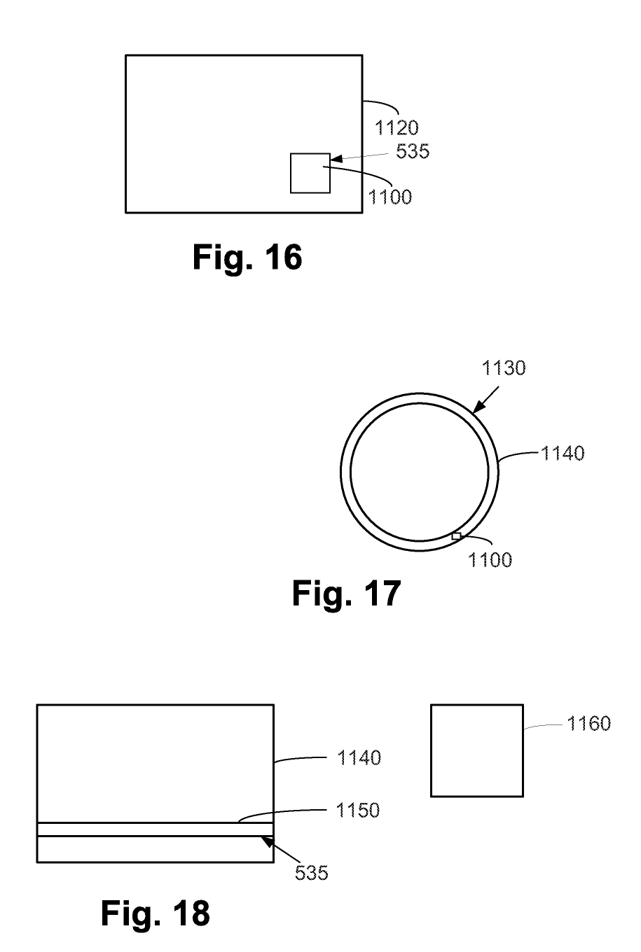

FIG. 15 shows the use of an RFID tag 1100 on the vessel 530. The RFID tag 1100 thus may be utilized in the same manner as the data storage medium 535 in the form of written indicia as described above. The RFID tag 1100 also may be positioned on other objects such as on a card 1120 shown in FIG. 16 or on a wearable device 1130 such as the wrist band 1140 shown in FIG. 17. By the term card, we mean any type of presentable card such as a credit card, a debit card, a loyalty card, a smart card, an identification card, and the like. The RFID tag 1100 simply needs to be on any surface within radio communication distance of the RFID reader 1110. Likewise, the wearable device 1130 may be any device that may be worn or carried by a consumer.

FIG. 18 shows a further embodiment of the card 1120 using a magnetic stripe 1150 as the data storage medium 535. The magnetic stripe 1150 also may be positioned on the vessel 530 or elsewhere. A magnetic strip reading device 1160 and the like also may be used. The magnetic strip 1150 thus may be utilized in the same manner as the data storage medium 535 in the form of written indicia or the RFID tag as described above. Any other type of data storage medium may be used herein, either alone or in combination.

In addition to activation of the beverage dispensing system 450, the use of the user interface devices 520 and the various types of data storage mediums 535 may communicate to manage effectively the dispensing of numerous beverages or other products under controlled circumstances. For example, the data storage mediums 535 may indicate the type and volume of beverages to be dispensed, a set number of refills, a set number of ounces, a set time period, or any other type of dispense control. In such a manner, a consumer may pre-buy a number of refills or ounces and then have the ability to fill the vessel 530 as desired. Moreover, the data storage mediums 535 also may include an identification for the vessel 530 such that the vessel 530 may be filled at distinct locations. Specifically, multiple beverage dispensing system 450 may be in communication with the data processing system 800 and communication therewith. The data processing system 800 may instruct the beverage dispensing systems 450 to stop dispensing once the predetermined limits have been reached. Any other type of dispensing controls may be used herein.

The capabilities herein may be implemented in software, firmware, hardware or some combination thereof. As one example, one or more aspects described herein may be included in an article of manufacture (e.g., one or more computer program products) having, for instance, computer usable media. The media may have embodied therein, for instance, computer readable program code means for providing and facilitating the capabilities herein. The article of manufacture may be included as a part of a computer system or sold separately. Additionally, at least one program storage device readable by a machine, tangibly embodying at least one program of instructions executable by the machine to perform the capabilities described herein may be provided.

The flow diagrams depicted herein are just examples. There may be many variations to these diagrams or the steps (or operations) described herein without departing from the spirit of the invention. For instance, the steps may be performed in a differing order, or steps may be added, deleted, or modified. All of these variations are considered a part of the claimed invention.

It should be apparent that the foregoing relates only to the preferred embodiments of the present application and that numerous changes and modifications may be made herein by one of ordinary skill in the art without departing from the general spirit and scope of the invention as defined by the following claims and the equivalents thereof.

We claim:

1. A product dispensing system for dispensing one of a number of predetermined products, comprising:
a product dispenser;
the product dispenser comprising a plurality of micro-ingredients to create the predetermined product;
a reading device configured to read or receive data;
a container for receiving the predetermined product; and
a data storage medium with the data thereon.

2. The product dispensing system of claim 1, wherein the data storage medium comprises a tag positioned on the container.

3. The product dispensing system of claim 1, wherein the data storage medium comprises a tag positioned on a card.

4. The product dispensing system of claim 1, wherein the data storage medium comprises a tag positioned on a wearable article.

5. The product dispensing system of claim 4, wherein the wearable article comprises a wrist band.

6. The product dispensing system of claim 1, wherein the data storage medium comprises a bar code and wherein the reading device comprises a bar code reader.

7. The product dispensing system of claim 1, wherein the data storage medium comprises an RFID tag and wherein the reading device comprises an RFID reading/writing device.

8. The product dispensing system of claim 1, wherein the data storage medium comprises a magnetic strip and wherein the reading device comprises a magnetic strip reading device.

9. The product dispensing system of claim 1, wherein the data comprises a volume of the predetermined product permitted to be received into the container.

10. The product dispensing system of claim 1, wherein the data comprises a number of refills of the predetermined product permitted to be received into the container.

11. The product dispensing system of claim 1, wherein the data comprises a time period for refills of the predetermined product permitted to be received into the container.

12. The product dispensing system of claim 1, wherein the data comprises the predetermined product permitted to be received into the container.

13. The product dispensing system of claim 1, wherein the data comprises an identification of the container.

14. The product dispensing system of claim 1, further comprising a control and wherein a plurality of product dispensers and a plurality of reading devices are in communication with the control.

15. The product dispensing system of claim 1, wherein the product dispenser comprises one or more macro-ingredients and one or more diluents for mixing with the plurality of micro-ingredients.

16. A beverage dispensing system for dispensing one of a number of predetermined beverages, comprising:
a beverage dispenser;
the beverage dispenser comprising a plurality of micro-ingredients to create the predetermined beverage;
a reading device configured to read or receive data;
a vessel for receiving the predetermined beverage; and
a tag with the data thereon.

17. The beverage dispensing system of claim 16, wherein the tag is positioned on the vessel.

18. The beverage dispensing system of claim 16, wherein the tag is positioned on a card.

19. The beverage dispensing system of claim 16, wherein the tag is positioned on a wearable article.

20. A method of dispensing a beverage for a consumer, comprising:
receiving a request for the beverage;
preparing the beverage by mixing a plurality of micro-ingredients, one or more macro-ingredients, and one or more diluents;
dispensing the beverage into a container;
providing refill data to the consumer; and
refilling the container with the beverage according to the refill data.
